(19) United States
(12) Patent Application Publication
(10) Pub. No.: US 2018/0313297 A1
(43) Pub. Date: Nov. 1, 2018

(54) TURBOFAN NACELLE INCLUDING A REVERSER FLAP

(71) Applicants: Airbus Operations (S.A.S.), Toulouse (FR); Airbus (S.A.S.), Blagnac (FR)

(72) Inventors: Thierry Surply, Cornebarrieu (FR); Romain CUSSET, TOULOUSE (FR); Benjamin PESSEY, TOULOUSE (FR); Guillaume CLAIRET, ENCAUSSE (FR)

(21) Appl. No.: 15/967,535

(22) Filed: Apr. 30, 2018

Related U.S. Application Data
(63) Continuation-in-part of application No. 15/823,053, filed on Nov. 27, 2017.

(30) Foreign Application Priority Data
Nov. 28, 2016 (FR) 1661549

(51) Int. Cl. F02K 1/72; B64D 27/16

(52) U.S. Cl. CPC F02K 1/72; B64D 27/16; F05D 2260/57; F05D 2240/14; F05D 2240/55; F05D 2220/323

(57) ABSTRACT

A nacelle has a fixed cowl and a mobile cowl, which is movable along a translation path between closed and open positions, a window delimited by the fixed cowl and the mobile cowl and open between an airflow and exterior of the nacelle, a reverser flap rotatably mounted to move between closed and open positions, and a drive mechanism configured to control passage of the reverser flap between the closed and open positions as the mobile cowl moves between the closed and open positions. From the closed positions, the drive mechanism assures a translation of the mobile cowl and a rotation of the reverser flap toward their respective open positions. From the open positions, the drive mechanism assures a rotation of the reverser flap and a translation of the mobile cowl toward the closed position. In some embodiments, the nacelle further includes an additional, or second, flap.

### CROSS-REFERENCE TO RELATED APPLICATIONS

This application is a continuation-in-part of co-pending U.S. patent application Ser. No. 15/823,053, filed Nov. 27, 2017, which claimed priority to French Patent Application FR 16 61549, filed Nov. 28, 2016, the contents of which are incorporated by reference herein in their entireties.

### TECHNICAL FIELD

The present disclosure concerns a turbofan nacelle that includes at least one reverser flap, a turbofan including a nacelle of that kind and an engine, and an aircraft including at least one such turbofan.

### BACKGROUND

An aircraft includes a fuselage to each side of which is fixed a wing. Under each wing is suspended at least one turbofan. Each turbofan is fixed under the wing by, for example, a pylon that is fixed between the structure of the wing and the structure of the turbofan.

The turbofan includes an engine and a nacelle that is fixed around the engine.

The nacelle includes at least one reverser flap that is mobile between a closed position in which it becomes continuous with the exterior surface of the nacelle and an open position in which it opens a window in the wall of the nacelle to expel the air of the secondary flow to the outside.

The reverser flap is mounted mobile in rotation on the structure of the nacelle so as to pass from a closed position, in which the reverser flap does not obstruct the secondary flow airflow, to an open position, in which the reverser flap obstructs the airflow.

Accordingly, in the open position, the reverser flap diverts a part of the secondary flow to the outside via the window.

Although the mechanism of a reverser flap of this kind is entirely satisfactory, it is desirable to find different mechanisms.

### SUMMARY

In a first example embodiment, a nacelle for a turbofan is disclosed. In this example, the nacelle comprises: a fixed cowl and a mobile cowl, the mobile cowl being mobile along a translation path between a closed position, in which the mobile cowl is adjacent to the fixed cowl, and an open position, in which the mobile cowl is far aft of the fixed cowl, wherein a passage is defined for a primary airflow between, on an inner surface thereof, an engine of the turbofan and, on an outer surface thereof, the fixed cowl and the mobile cowl; a window, which is delimited, on an upstream side thereof, by the fixed cowl and, on a downstream side thereof, by the mobile cowl, wherein, when the mobile cowl is in the open position, the window is open to allow a secondary flow to exit the passage for the primary airflow to an exterior of the nacelle through the window; a reverser flap which is mounted in a manner rotatable about a rotation axis between a closed position, in which the window is obstructed, and an open position, in which the window is not obstructed; a drive mechanism comprising: a motor element with a mobile part secured to the mobile cowl to drive the mobile part in translation, a guide, which is secured to the mobile cowl and comprises a slide part, an axis of which is parallel to the translation path of the mobile cowl, and a rotation part that extends the slide part forward and is offset relative to the slide part, a slider of the rotation part accommodated in the guide, a first link articulated between the slider and the reverser flap, a second link articulated between the slider and the second flap, and an abutment configured to move the slider toward the slide part when the reverser flap and the second flap are in the closed position and the mobile cowl is moved from the open position to the closed position; a second flap configured to rotate about a rotation axis between the closed position, in which the second flap is positioned out of the passage for the primary airflow, and the open position, in which the second flap is positioned within, at least partially, the passage for the primary airflow, and to extend the reverser flap in the open position to be located within, at least partially, the passage for the primary airflow; and a plurality of deflectors that are arranged in a position such that, when the window is open, the plurality of deflectors are positioned at a leading edge of the window; wherein the drive mechanism is configured to control passage of the reverser flap and the mobile cowl between and including the closed and open positions; wherein the drive mechanism is configured for a first combination assuring, from the closed position: an aft translation of the mobile cowl along the translation path to move the mobile cowl from the closed position to the open position, and a rotation of the reverser flap about the rotation axis to move the reverser flap from the closed position to the open position; wherein the drive mechanism is configured for a second combination assuring, from the open position: a rotation of the reverse flap in a reverse direction about the rotation axis to move the reverser flap from the open position to the closed position, and a forward translation of the mobile cowl along the translation path to move the mobile cowl from the open position to the closed position; and wherein the drive mechanism is configured to coordinate passage of the second flap and the reverser flap between and including the closed and open positions.

In a second example embodiment, a nacelle for a turbofan is disclosed. According to this embodiment, the nacelle comprises: a fixed cowl and a mobile cowl, the mobile cowl being mobile along a translation path between a closed position, in which the mobile cowl is adjacent to the fixed cowl, and an open position, in which the mobile cowl is far aft of the fixed cowl, wherein a passage is defined for a primary airflow between, on an inner surface thereof, an engine of the turbofan and, on an outer surface thereof, the fixed cowl and the mobile cowl; a window, which is delimited, on an upstream side thereof, by the fixed cowl and, on a downstream side thereof, by the mobile cowl, wherein, when the mobile cowl is in the open position, the window is open to allow a secondary flow to exit the passage for the primary airflow to an exterior of the nacelle through the window; a reverser flap which is mounted in a manner rotatable about a rotation axis between a closed position, in which the window is obstructed, and an open position, in which the window is not obstructed; a drive mechanism comprising: an actuator with a first rod, which is secured to the mobile cowl, and a second rod, an activator configured to selectively move the first rod and the second rod, a first link articulated between the second rod and the reverser flap, and a second link articulated between the second rod and the second flap; a second flap configured to rotate about a rotation axis between the closed position, in which the second flap is positioned out of the passage for the primary airflow, and the open position, in which the second flap is positioned within, at least partially, the passage for the primary airflow, and to extend the reverser flap in the open position to be located within, at least partially, the passage for the primary airflow; and a plurality of deflectors that are arranged in a position such that, when the window is open, the plurality of deflectors are positioned at a leading edge of the window; wherein the drive mechanism is configured to control passage of the reverser flap and the mobile cowl between and including the closed and open positions; wherein the drive mechanism is configured for a first combination assuring, from the closed position: an aft translation of the mobile cowl along the translation path to move the mobile cowl from the closed position to the open position, and a rotation of the reverser flap about the rotation axis to move the reverser flap from the closed position to the open position; wherein the drive mechanism is configured for a second combination assuring, from the open position: a rotation of the reverse flap in a reverse direction about the rotation axis to move the reverser flap from the open position to the closed position, and a forward translation of the mobile cowl along the translation path to move the mobile cowl from the open position to the closed position; and wherein the drive mechanism is configured to coordinate passage of the second flap and the reverser flap between and including the closed and open positions.

According to one particular embodiment, the drive mechanism is adapted or configured to move the reverser flap and the mobile cowl simultaneously.

According to another particular embodiment, the drive mechanism is adapted or configured to assure a delayed movement of the reverser flap in the first combination and a delayed movement of the mobile cowl in the second combination.

According to one particular embodiment, the drive mechanism includes a first actuator mounted articulated between the reverser flap and a structure of the nacelle, at least one second actuator mounted articulated between the mobile cowl and the structure of the nacelle, and a control unit adapted or configured to control the lengthening and the shortening of each actuator

According to another particular embodiment, the drive mechanism includes at least one articulated link mounted between the reverser flap and the mobile cowl, at least one second articulated actuator mounted between the mobile cowl and the structure of the nacelle, and a control unit adapted or configured to control the lengthening and the shortening of each second actuator.

Each second actuator is advantageously equipped with a brake that is controlled by the control unit and locks the second actuator in position.

The drive mechanism advantageously includes two second actuators and a fixed connection between the rods of the two second actuators.

According to another particular embodiment, the drive mechanism includes two racks fixed to the mobile cowl and aligned with the translation direction, a pinion for each rack fixed to the structure of the nacelle to mesh with the teeth of the rack, a motor adapted or configured to drive each pinion in rotation, and a control unit adapted or configured to control the motor.

According to some embodiments, the plurality of deflectors are configured to increase a mass flow rate of the secondary flow through a region of the window in which the plurality of deflectors are arranged.

In some other embodiments, the plurality of deflectors are located between an internal surface and an external surface of the mobile cowl.

In still other embodiments, the plurality of deflectors are located within a region between a translation path of the mobile cowl and a movement path of the second flap. In some such embodiments, the movement path of the second flap is defined by a leading edge of an internal surface of the mobile cowl.

The disclosure herein also discloses a turbofan including an engine and any of the above variants of a nacelle surrounding the engine and in which a secondary airflow is delimited between the nacelle and the engine.

The disclosure herein also discloses an aircraft including at least one turbofan in accordance with the above variant.

### BRIEF DESCRIPTION OF THE DRAWINGS

The features of the disclosure herein mentioned above along with others will become more clearly apparent on reading the following description of one embodiment, the description being given with reference to the appended drawings, in which:

FIG. 1 is a side view or an aircraft including a nacelle according to the disclosure herein;

FIG. 2 is a perspective view of the nacelle according to the disclosure herein in an open configuration;

FIG. 3 is a section on a radial plane of the nacelle according to the disclosure herein in an open configuration;

FIG. 4 is a top view of the nacelle according to the disclosure herein in the open configuration for a first variant of a drive mechanism;

FIG. 5 is a top view of the nacelle according to the disclosure herein in the open configuration for a second variant of a drive mechanism;

FIGS. 6A and 6B are diagrammatic sectional representations of a nacelle in closed and open positions, respectively, according to another variant of the disclosure herein;

FIGS. 7A-7C show one embodiment of a connection between a mobile cowl and a reverser flap in various positions;

FIGS. 8A-8C show another embodiment of a connection between a mobile cowl and a reverser flap in various positions;

FIGS. 9A-9C are diagrammatic sectional representations of a nacelle in closed and open positions, according to a further variant of the disclosure herein; and

FIG. 10 shows a reverse thrust secondary airflow pattern when the nacelle shown in FIGS. 9A-C is in the open position, according to the disclosure herein.

### DETAILED DESCRIPTION

In the following description, terms relating to a position are referred to an aircraft in a forward movement position as shown in FIG. 1.

FIG. 1 shows an aircraft 10 that includes a fuselage 12 to each side of which is fixed a wing 14 that carries at least one turbofan 100 according to the disclosure herein. The turbofan 100 is fixed under the wing 14 by a pylon 16.

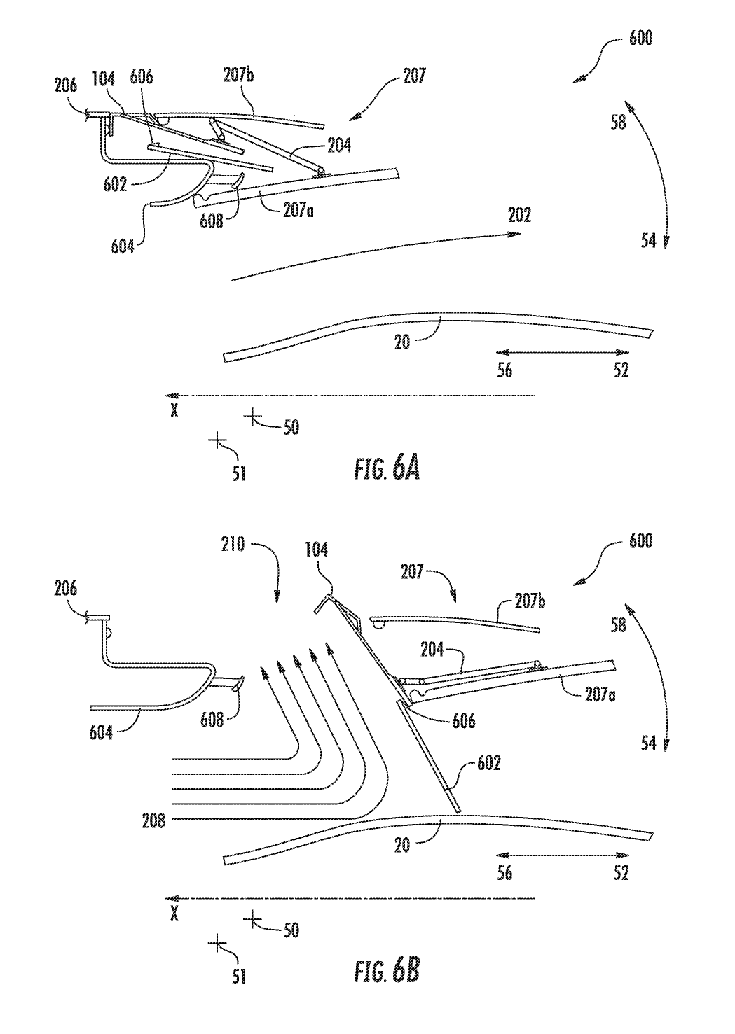

FIGS. 1 through 5 show a nacelle 102 according to a first embodiment of the disclosure herein and FIG. 6 shows a nacelle 600 according to a second embodiment of the disclosure herein.

The turbofan 100 includes a nacelle 102, 600 and an engine that is housed inside the nacelle 102.

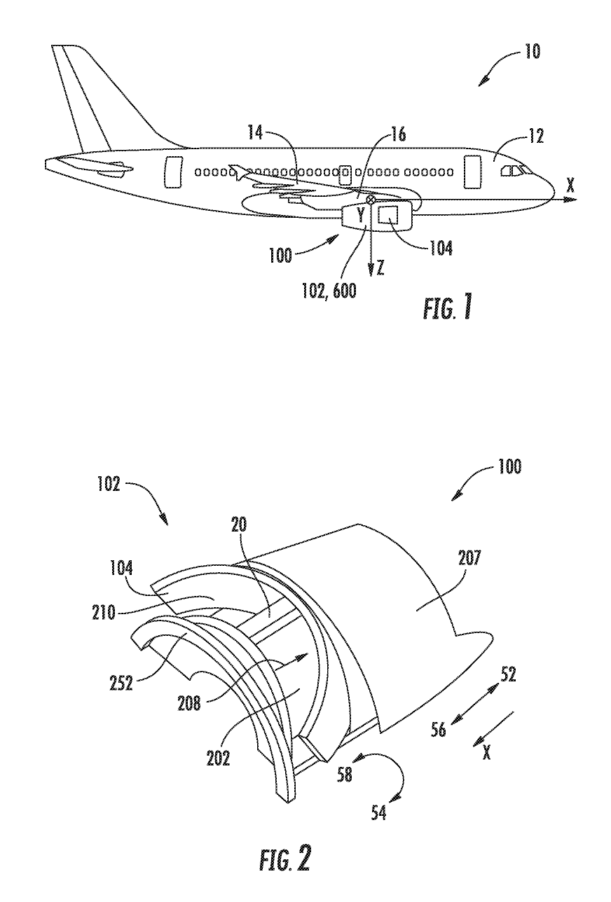

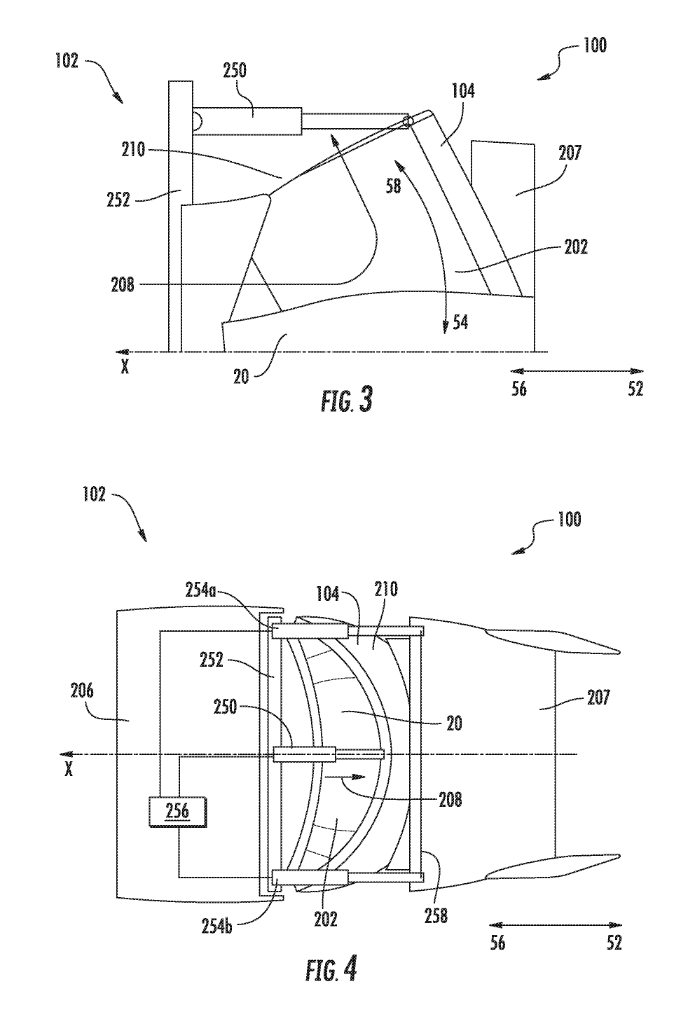

As shown in FIGS. 2 through 4, as well as in FIGS. 5 and 6, the turbofan 100 has a primary airflow 202 between the nacelle 102 and the engine 20 in which the secondary flow 208 circulates.

In the following description, and by convention, x denotes the longitudinal axis of the nacelle 102 that is parallel to the longitudinal or roll axis X of the aircraft 10 oriented positively in the direction of forward movement of the aircraft 10, Y denotes the transverse axis or pitch axis of the aircraft which is horizontal when the aircraft is on the ground, and Z denotes the vertical axis or vertical height or yaw axis when the aircraft is on the ground, these three directions X, Y and Z being mutually orthogonal and forming an orthonomic frame of reference the origin of which is the centre of gravity of the aircraft.

The nacelle 102 includes at least one reverser flap 104. In particular, there can be two reverser flaps 104 disposed one in front of the other, or four reverser flaps 104 regularly distributed over the periphery of the nacelle 102.

In the following description the disclosure herein is more particularly described for one reverser flap 104, but the description applies in the same manner to each reverser flap 104 when there is more than one of them.

For each reverser flap 104 the nacelle 102 includes an open window 210 between the primary airflow 202 and the exterior of the nacelle 102.

The nacelle 102 features a fixed cowl 206 that delimits the window 210 on the upstream side relative to the longitudinal axis x and that is fixedly mounted on a structure of the nacelle 102.

The nacelle 102 features a mobile cowl 207 that delimits the window 210 on the downstream side relative to the longitudinal axis x. The mobile cowl 207 is mounted mobile in translation in a translation direction globally parallel to the longitudinal axis x on the structure of the nacelle 102. The translation is effected by any appropriate mechanism and/or structure, such as, for example, slides.

The fixed cowl 206 and the mobile cowl 207 feature an exterior surface that constitutes the exterior envelope of the nacelle 102 and an interior surface that constitutes an exterior wall of the primary airflow 202.

The mobile cowl 207 is mobile between a closed position, in which it is close to the fixed cowl 206, and an open position, in which it is far aft of the fixed cowl 206 so as to open (e.g., vacate the area associated with) the window 210.

The reverser flap 104 is mounted mobile in rotation about a rotation axis on the structure of the nacelle 102 between a closed position in which it obstructs the window 210 and an open position in which it does not obstruct the window 210. Here, in the embodiment of the disclosure herein shown in FIGS. 2 through 4, the rotation axis is perpendicular to the longitudinal axis x.

In the closed position, the reverser flap 104 is positioned between the fixed cowl 206 and the mobile cowl 207, which is in the closed position, and the reverser flap 104 extends the mobile cowl 207 and the fixed cowl 206 extends the reverser flap 104. In the open position the mobile cowl 207 is moved aft to facilitate the manoeuvring of the reverser flap 104 from the closed position to the open position.

When the reverser flap 104 is in the closed position, the exterior surface of the reverser flap 104 extends between the exterior surface of the fixed cowl 206 and the exterior surface of the mobile cowl 207 and its interior surface extends between the interior surface of the fixed cowl 206 and the interior surface of the mobile cowl 207 to delimit the primary airflow 202.

When the reverser flap 104 is in the open position, the reverser flap 104 crosses the passage for the primary airflow 202 and diverts at least a portion thereof to the outside through the window 210, generating the secondary flow 208.

The passage of the reverser flap 104 from the closed position to the open position is coordinated with the passage of the mobile cowl 207 from the closed position to the open position, and vice versa.

This coordination is assured by a drive mechanism that, starting from the closed position, realizes a first combination assuring:

an aft translation (arrow 52) of the mobile cowl 207 in a translation direction globally parallel to the longitudinal axis x that assures the movement of the mobile cowl 207 from the closed position to the open position, and

a rotation (arrow 54) of the reverser flap 104 about the rotation axis that assures the movement of the reverser flap 104 from the closed position to the open position.

Conversely, the passage of the reverser flap 104 from the open position to the closed position is assured by the same mechanism that is also adapted or configured to realize a second combination assuring from the open position:

a rotation in the reverse direction (arrow 58) of the reverser flap 104 about the rotation axis that assures the return of the reverser flap 104 from the open position to the closed position, and

a forward translation (arrow 56) of the mobile cowl 207 in the translation direction that assures the movement of the mobile cowl 207 from the open position to the closed position.

The references in FIGS. 6A and 6B that are identical to the references of the previous embodiment represent the same elements. FIG. 6A shows the elements in the closed position, while FIG. 6B shows the same elements in the open position. The elements described with reference to the previous embodiments apply equally to the embodiment of FIGS. 6A through 10.

In the embodiment of FIGS. 6A and 6B, the reverser flap 104 has a length along the longitudinal axis x that is reduced relative to that of the previous embodiment.

To fill the gap between the reverser flap 104 and the engine 20 the nacelle, generally designated 600, features an additional, or second, flap 602, which, when in the open position, extends between the reverser flap 104 and the engine 20 in order to obstruct the primary airflow 202, thereby creating a secondary flow 208. The provision of the second flap 602 of this kind also makes it possible to improve the forward deviation of the secondary flow 208 and to reduce noise associated with generating the secondary flow 208.

The second flap 602 is mobile between the closed (e.g., retracted) position (FIG. 6A), in which it is not positioned to block the primary airflow 202, and the open (e.g., active) position (FIG. 6B), in which it is positioned across (e.g., to block) the primary airflow 202 to generate the secondary flow 208. The passage of the second flap 602 from its closed position to its open position is affected in a manner coordinated with the passage of the mobile cowl 207 from its closed position to its open position, and vice versa. In the open position, the second flap 602 extends the reverser flap 104 in its open position blocking the passage for the primary airflow 202 as far as the engine 20 to generate the secondary flow 208 through the window 210 opened when the mobile cowl 207 moves from the closed position to the open position.

In the embodiment of the disclosure shown in FIGS. 6A and 6B the mobile cowl, generally designated 207, features an interior wall 207a and an exterior wall 207b that are moved in the same manner and simultaneously. The exterior wall 207b is the wall that comes into alignment with the reverser flap 104 in the closed position (see FIG. 6A) and constitutes an exterior wall of the nacelle 600, while the interior wall 207a defines the peripheral surface of the passage for the primary airflow 202 around the engine 20.

FIG. 6A shows the components of the nacelle 600 in the closed position, with the reverser flap 104 being accommodated in part between the interior wall 207a and the exterior wall 207b, and the second flap 602 being in its closed position and accommodated between the interior wall 207a and the exterior wall 207b.

FIG. 6B shows the components of the nacelle 600 in the open position, with the reverser flap 104 and the second flap 602 in their respective open positions positioned upstream (e.g., relative to the direction of primary airflow 202) of the interior wall 207a and the exterior wall 207b and, furthermore, positioned across the passage that defines the primary airflow 202, at least partially or entirely blocking the flow of the primary airflow 202.

The nacelle 600 also features an upstream wall 604 that extends upstream of the interior wall 207a, relative to the longitudinal axis x, and constitutes an exterior wall of the passage for the primary airflow 202 around the engine 20. The upstream wall 604 is fixed relative to the structure of the nacelle 600 and is situated substantially at the level of the front frame. In the closed position, at an upstream end, the interior wall 207a is located proximate to and extending the upstream wall 604. In the open position, the interior wall 207a is located far away from the upstream wall 604 so as to open the window 210 and allow the reverser flap 104 and the second flap 602 to be positioned to block or obstruct the primary airflow 202.

As described in previous example embodiments, the reverser flap 104 is mounted mobile in rotation about a rotation axis 50 on the structure of the nacelle 600 to pass from the closed position to the open position, and vice versa.

The movements of the mobile cowl 207 and the reverser flap 104 conform to those described above and are assured by an appropriate drive mechanism.

In the embodiment of the disclosure herein shown in FIGS. 6A and 6B, the drive mechanism is configured to move the mobile cowl 207 from the closed position to the open position, and vice versa and, to this end, can include, for example, slides, actuators, motors, or any other appropriate mechanisms and/or structures for moving an element in translation.

In the embodiment shown in FIGS. 6A and 6B, the drive mechanism also comprises a set of links 204, comprising two links 204 articulated to each other. The end of a first link 204 is articulated to the mobile cowl 207 (e.g., to the interior wall 207a) The end of the second link 204 is articulated to the reverser flap 104. Any suitable number of links may be used.

The movement of the mobile cowl 207 therefore drives a movement of the links 204 that pulls or pushes, depending on the direction of movement of the mobile cowl 207, the reverser flap 104 from and between the closed position (e.g., FIG. 6A) and the open position (e.g., FIG. 6B).

In this embodiment, the second flap 602 is also mounted mobile in rotation about a rotation axis 51 on the structure of the nacelle 600 to pass between and including its closed and open positions, and vice versa. In this embodiment, the two rotation axes 50 and 51 are different, but in other configurations they can be identical (e.g., co-located along a single axis).

The movements of the second flap 602 are similar to and synchronized with those of the reverser flap 104. To this end the drive mechanism is configured to coordinate the movements of the second flap 602 with those of the reverser flap 104; that is to say, the passage of the second flap 602 between and including its closed and open positions is coordinated with the passage of the reverser flap 104 between and including its respective closed and open positions, and vice versa. This coordinated movement is achieved, in the example embodiment shown, by links 204 connecting the second flap 602 and the reverser flap 104 and a motor, or actuators, controlled as a function of the movement of the reverser flap 104.

To provide a good seal (e.g., a substantially hermitic seal) between the reverser flap 104 and the second flap 602, the second flap 602 comprises a seal 606 of the lip seal type that is pressed against the reverser flap 104 when the second flap 602 and the reverser flap are in their respective open positions. The seal 606 is, therefore, positioned between the reverser flap 104 and the second flap 602 to substantially prevent an airflow therethrough.

For even better control of the secondary flow 208 when the window 210 is open, the nacelle 600 includes at least one deflector 608, which can also be referred to for example as a cascade or mini-cascade, that is attached to the upstream wall 604 in a manner that protrudes, at least partially, into the opening for the secondary flow 208 that is defined by the window 210 (e.g., globally at the level of the zone of the transition from the passage for the primary airflow 202 to the window 210).

Each deflector 608 is fixed to the structure of the nacelle 600 and, in the embodiment shown, is fixed to the upstream wall 604. Each deflector 608 takes the form of an aileron that orients the secondary flow 208 toward the window 210.

In the closed position, each deflector 608 is accommodated in the mobile cowl 207, i.e. between the interior wall 207a and the exterior wall 207b.

The drive mechanism can be adapted or configured to assure simultaneous movements of the reverser flap 104 and the mobile cowl 207 in the two combinations provided that the dimensional characteristics of the reverser flap 104 and the mobile cowl 207 do not create any interference between them during their movements.

The drive mechanism can also be adapted or configured to assure a delayed movement of the reverser flap 104 in the first combination and a delayed movement of the mobile cowl 207 in the second combination.

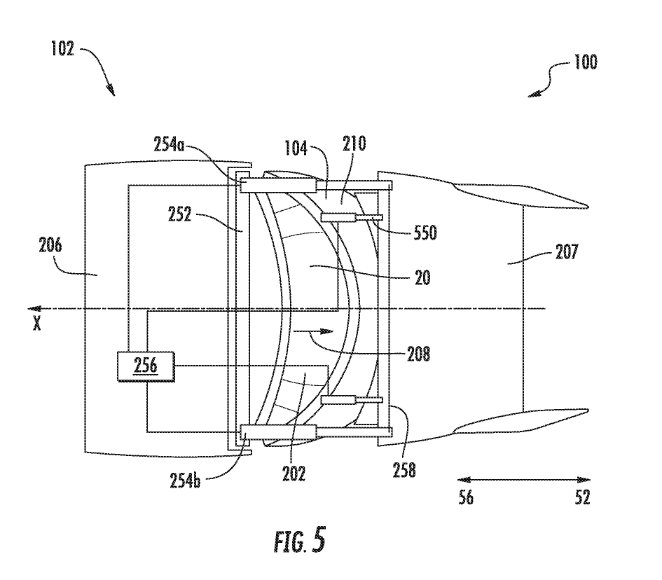

In the embodiment of the disclosure herein shown in FIGS. 3 and 4, the drive mechanism includes a first articulated actuator 250 mounted between the reverser flap 104 and the structure of the nacelle 102, in particular with the front frame 252, and at least one second articulated actuator 254a-b (here two of them) mounted between the mobile cowl 207 and the structure of the nacelle 102, in particular with the front frame 252.

Each actuator 250, 254a-b can be electric, hydraulic or pneumatic or otherwise.

The drive mechanism also includes a processor type control unit 256 that controls the lengthening and the shortening of each actuator 250, 254a-b according to the requirements of the aircraft 10 whether simultaneously or in a deferred manner.

Here the cylinder of the second actuator 254a-b is articulated to the front frame 252 and the rod is articulated to the mobile cowl 207.

Here the cylinder of the first actuator 250 is articulated to the front frame 252, and the rod is articulated to the reverser flap 104.

The control unit 256 therefore commands the extension of the actuators 250 and 254a-b to pass from the closed position to the open position and conversely the retraction of the actuators 250 and 254a-b to pass from the open position to the closed position.

To assure the locking of the mobile cowl 207 in the open position each second actuator 254a-b is equipped with a brake that is controlled by the control unit 256 and locks the second actuator 254a-b in position.

It is equally possible for the reverser flap 104 to be retained in its closed position by a set of locks assuring the retention of the reverser flap 104 in the closed position and to comply with aerodynamic constraints.

When the drive mechanism includes two second actuators 254a-b, to prevent too great an offset between the positions of the two second actuators 254a-b the drive mechanism includes a link 258 fixed between the rods of the two second actuators 254a-b and if a second actuator 254a lags behind the other second actuator 254b the link 258 therefore pulls on the lagging second actuator 254a.

FIG. 5 shows a variant embodiment in which the first actuator 250 is replaced by at least one articulated link 550 mounted between the reverser flap 104 and the mobile cowl 207. In this case the movements of the reverser flap 104 and the mobile cowl 207 are synchronized.

The link or links 550 can be disposed centrally or at the sides of the mobile cowl 207.

To desynchronize movements of the reverser flap 104 and the mobile cowl 207 the link is connected to the mobile cowl 207 by a mobile fitting driven by the mobile cowl from a position allowing rotation of the reverser flap 104 without interference with the mobile cowl 207.

In another embodiment each of the two second actuators 254a-b is replaced by a rack system and the drive mechanism therefore includes two racks fixed to the mobile cowl 207 and aligned with the translation direction and, for each rack, a pinion fixed to the structure of the nacelle 102 and mobile in rotation about an axis perpendicular to the translation direction to mesh with the teeth of the rack. The drive mechanism also includes a motor controlled by a control unit and adapted or configured to drive each pinion in rotation. The transmission of movement between the motor and each pinion is effected via a transmission system that can comprise gears, flexible transmission shafts or otherwise. The control unit is of the same type as before.

The motor can be hydraulic or electric or otherwise.

The embodiments of the drive mechanism shown in FIGS. 3 through 5 can also be used in the context of FIG. 6, with the features associated with the coordinated movements of the mobile cowl 207 and the second flap 602 being added thereto.

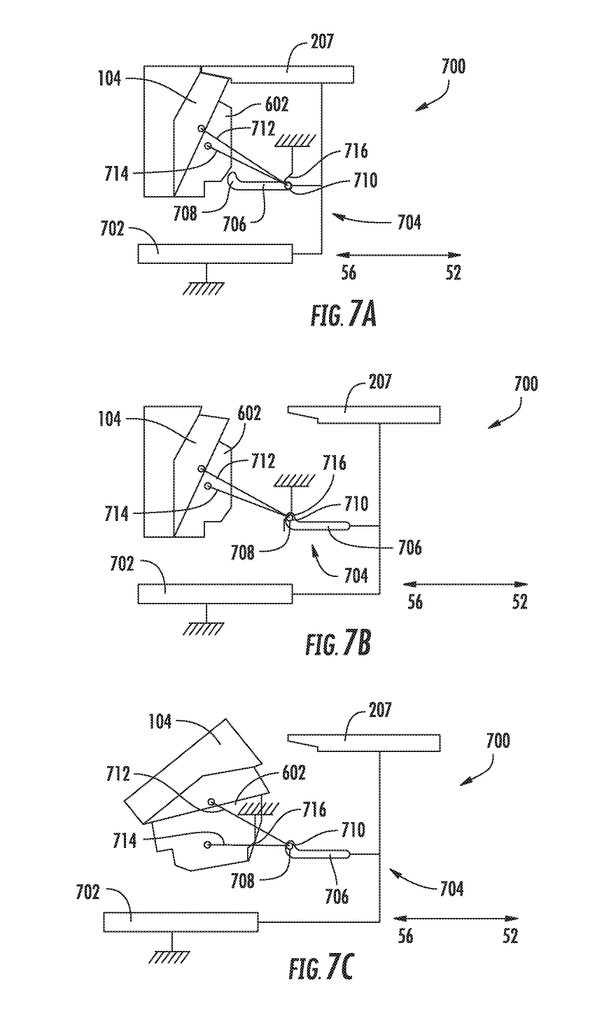

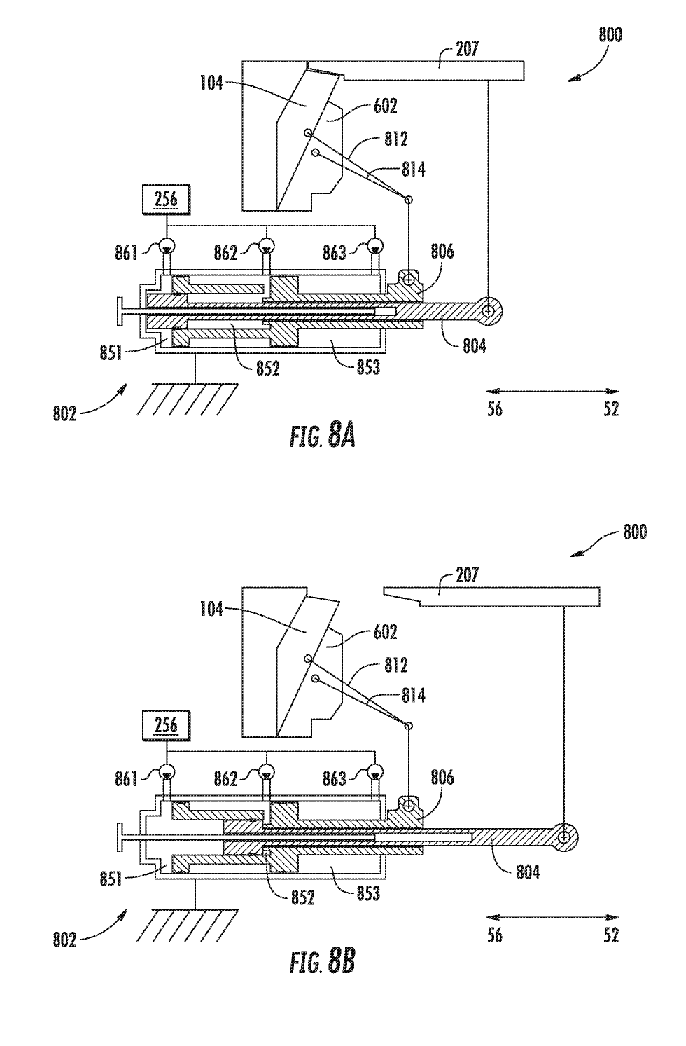

FIGS. 7A-C show an example of a drive mechanism 700 in a closed position in FIG. 7A, an open position in FIG. 7C and an intermediate position in FIG. 7B.

The drive mechanism 700 is described here in the context of the nacelle 600 with the reverser flap 104 and the second flap 602 and in this embodiment the movements of the reverser flap 104 and the second flap 602 are delayed relative to the movement of the mobile cowl 207.

The drive mechanism 700 includes a motor element 702 with a mobile part secured to the mobile cowl 207 to drive it in translation. The motor element 702 can for example be an actuator or a motor with a rack.

The drive mechanism 700 features a guide 704 secured to the mobile cowl 207 that includes a slide part 706, the axis of which is parallel to the direction of translation of the mobile cowl 207, and a rotation part 708 that extends forward the slide part 706 and is offset relative to the slide part 706 relative to the translation direction.

The drive mechanism 700 also comprises a slider 710 accommodated in the guide 704.

The drive mechanism 700 also comprises a first articulated link 712 between the slider 710 and the reverser flap 104 and a second articulated link 714 between the slider 710 and the second flap 602.

The drive mechanism 700 also comprises an abutment 716 that is adapted or configured to move the slider 710 of the rotation part 708 toward the slide part 706 when the reverser flap 104 is in the closed position, the second flap 602 is in the closed position, and the mobile cowl 207 moves from the open position to the closed position. Here the abutment 716 takes the form of a ramp that runs down the slider 710.

Operation is then as follows, starting from the closed position:

the motor element 702 moves the mobile cowl 207 and the guide 704 in the aft direction 52,

the slider 710 remains immobile as long as it is in the slide part 706 and neither the reverser flap 104 nor the second flap 602 moves,

when the slider 710 has reached the end of the slide part 706, it reaches the rotation part 708 (FIG. 7B), which then constrains the slider 710 to move with the guide 704, which continues to be moved aft in translation by the motor element 702, and

the continuing translation of the guide 704 in the aft direction 52 drives the movement of the slider 710 in the same direction, which pulls on the first link 712 and the second link 714, causing rotation of the reverser flap 104 and the second flap 602, respectively, as far as their open positions (FIG. 7C) and, at the same time, the mobile cowl 207 reaches its open position.

Operation is then as follows, starting from the open position:

the motor element 702 moves the mobile cowl 207 and the guide 704 in the forward direction 56 and, as the rotation part 708 is offset relative to the slide part 706, the slider 710 remains wedged therein and moves simultaneously in translation to cause the rotation of the reverser flap 104 and the second flap 602, respectively, as far as their closed positions (FIG. 7B), by pushing on the first link 712 and the second link 714,

the slider 710 then reaches the abutment 716 and the continuing translation of the guide 704 leads to movement of the slider 710 of the rotation part 708 toward the slide part 706,

the guide 704 continues to move in translation, whereas the slider 710 remains immobile in the slide part 706 until the mobile cowl 207 moves to its closed position (FIG. 7A).

Here the coordinated movement can be achieved by a structure or structures that includes, inter alia, the second link 714.

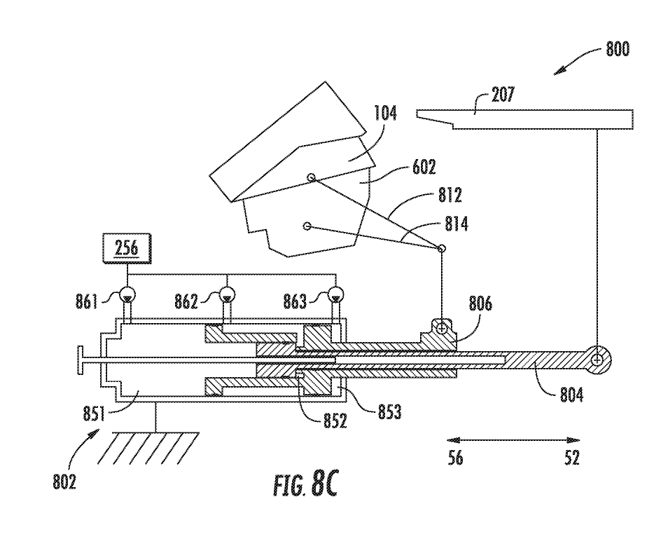

FIGS. 8A-C show an example of the drive mechanism 800 in a closed position in FIG. 8A, an open position in FIG. 8C and an intermediate position in FIG. 8B.

The drive mechanism 800 is described here in the context of the nacelle 600 with the reverser flap 104 and the second flap 602 and in this embodiment the movements of the reverser flap 104 and the second flap 602 are delayed relative to the movement of the mobile cowl 207.

The drive mechanism 800 includes an actuator 802 with two rods each constituting a mobile part. The first rod 804 is secured to the mobile cowl 207 to drive it in translation and the second rod 806 is secured to the reverser flap 104 and the second flap 602 to drive them in rotation. To this end the drive mechanism 800 comprises a first articulated link 812 between the second rod 806 and the reverser flap 104 and a second articulated link 814 between the second rod 806 and the second flap 602.

Each rod 804, 806 is mobile in translation parallel to the translation direction of the mobile cowl 207 between a closed (e.g., retracted) position (FIG. 8A) and an open (e.g., active, or deployed) position (FIG. 8C).

In the embodiment of the disclosure herein described here, the rods move in the same direction, but a different architecture is possible. In a similar manner, in the embodiment of the disclosure herein described here each rod passes from the closed position to the open position to pass from the closed position to the open position, and vice versa, but a different configuration is possible.

The actuator 802 features an activator, one particular embodiment of which is described hereinafter and is adapted or configured to selectively move the first rod 804 and the second rod 806.

Operation is then as follows, starting from the closed position:

the activator moves the first rod 804 aft in order to move the mobile cowl 207 in the aft direction 52 as far as an intermediate position (FIG. 8B),

the activator moves the first rod 804 and the second rod 806 in the aft direction 52 in order to move the mobile cowl 207 in the aft direction 52 to reach the open position and to pull on the first link 812 and the second link 814, causing the reverser flap 104 and the second flap 602 to rotate as far as its open position (FIG. 8C).

Operation is then as follows, starting from the respective open positions:

the activator moves the first rod 804 and the second rod 806 in the forward direction 56 in order to move the mobile cowl 207 in the forward direction 56 to reach the intermediate position (see FIG. 8B) and to push on the first link 812 and the second link 814, causing reverse rotation of the reverser flap 104 and the second flap 602 as far as the closed position (FIG. 8A),

the activator continues to move the first rod 804 forward in order to move the mobile cowl 207 forward as far as its closed position (FIG. 8A).

Here the coordinated movement can be achieved by a structure or structures that includes, inter alia, the second link 814.

The activator includes, in some embodiments, a hydraulic circuit that comprises:

a first chamber 851 defined between the end wall of the actuator 802 and the first rod 804,

a second chamber 852 defined between the first rod 804 and the second rod 806,

a third chamber 853 defined between the second rod 806 and the front part of the actuator 802,

a first pressure source 861 adapted or configured to pressurize the first chamber 851,

a second pressure source 862 adapted or configured to pressurize the second chamber 852,

a third pressure source 863 adapted or configured to pressurize the third chamber 853,

the control unit 256 adapted or configured to control each pressure source 861, 862, 863 in order for it to deliver a high pressure, a low pressure or an intermediate pressure.

In the closed position, the pressure distribution is as follows:

low pressure in the first chamber 851, and

high pressure in the second chamber 852 and the third chamber 853.

For the mobile cowl 207 to pass from the closed position to the intermediate position, the pressure distribution is as follows:

intermediate pressure in the first chamber 851,

low pressure in the second chamber 852, and

high pressure in the third chamber 853.

For the mobile cowl 207 to pass from the intermediate position to the open position and for the reverser flap 104 and the second flap 602 to pass from the closed position to the open position, the pressure distribution is as follows:

intermediate pressure in the first chamber 851, and

low pressure in the second chamber 852 and the third chamber 853.

For the mobile cowl 207 to pass from the open position to the intermediate position, and for the reverser flap 104 and the second flap 602 to pass to the closed position, the pressure distribution is as follows:

intermediate pressure in the first chamber 851,

low pressure in the second chamber 852, and

high pressure in the third chamber 853.

For the mobile cowl 207 to pass from the intermediate position to the closed position, the pressure distribution is as follows:

low pressure in the first chamber 851, and

high pressure in the second chamber 852 and the third chamber 853.

According to one particular embodiment, the high pressure is of the order of 200 bar, the low pressure is of the order of 4 bar, and the intermediate pressure is of the order of 100 bar.

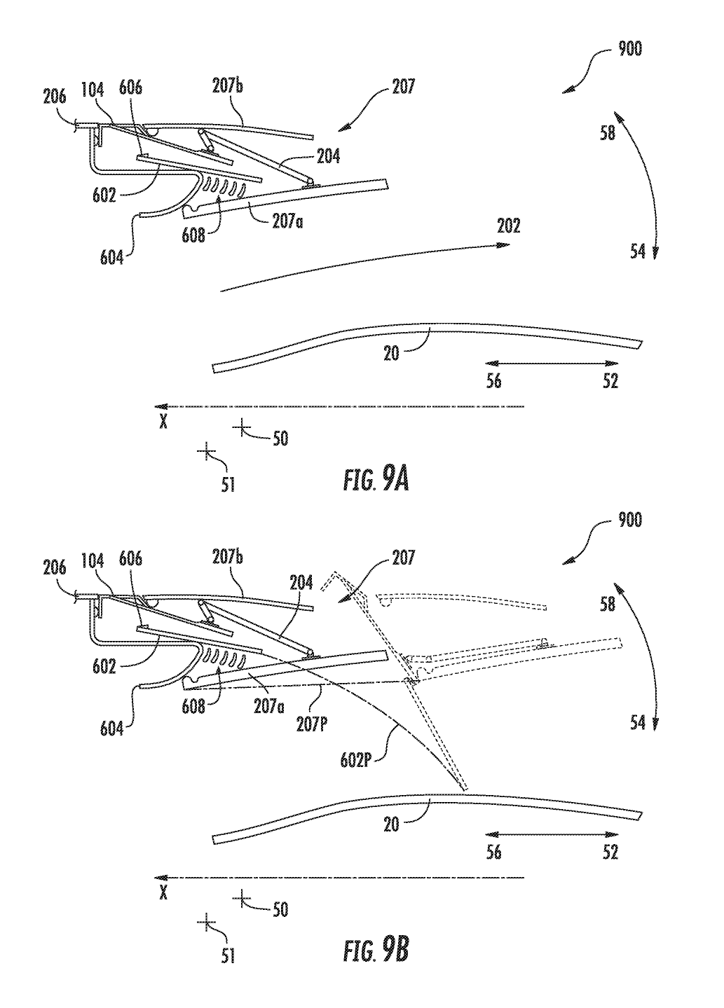

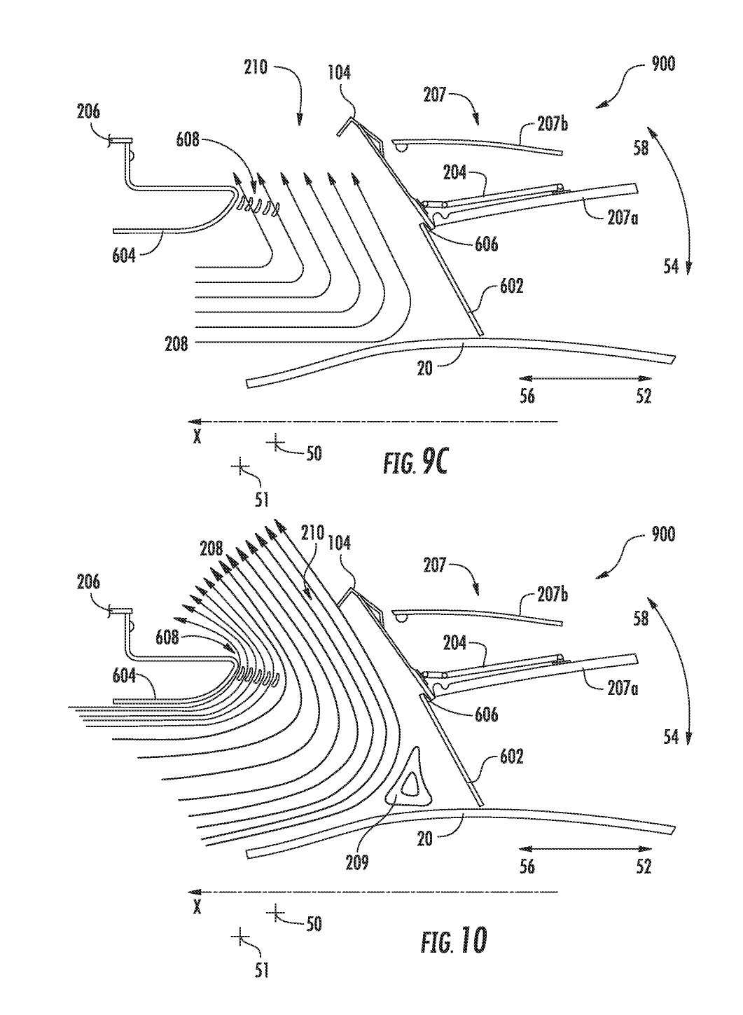

The reference numerals in FIGS. 9A, 9B, and 9C that are identical to the references of the previous embodiments of, for example, FIGS. 6A and 6B represent the same elements. FIG. 9A shows the elements in the closed position, while FIG. 9C shows the same elements in the open position. FIG. 9B shows the same elements illustrated in the closed position in the solid lines and in the open position in the broken lines. The elements described with reference to the previous embodiments apply equally to the embodiment of FIGS. 9A-9C and 10.

In the embodiment of FIGS. 9A-9C, just as was described relative to the embodiment of FIGS. 6A and 6B, the reverser flap 104 has a length along the longitudinal axis x that is reduced.

To fill the gap between the reverser flap 104 and the engine 20, the nacelle, generally designated 900, features an second flap 602, which, when in the open position (e.g., FIG. 9C), extends between the reverser flap 104 and the engine 20 in order to obstruct the primary airflow 202, thereby creating a secondary flow 208. The provision of the second flap 602 of this kind also makes it possible to improve the forward deviation of the secondary flow 208 (e.g., FIGS. 9C and 10) and to reduce noise associated with generating the secondary flow 208.

The second flap 602 is mobile between the closed (e.g., retracted) position (FIG. 9A), in which it is not positioned to block the primary airflow 202, and the open (e.g., active) position (FIG. 9C), in which it is positioned across (e.g., to block) the primary airflow 202 to generate the secondary flow 208. The passage of the second flap 602 from its closed position to its open position is affected in a manner coordinated with the passage of the mobile cowl 207 from its closed position to its open position, and vice versa. In the open position, the second flap 602 extends the reverser flap 104 in its open position blocking the passage for the primary airflow 202 as far as the engine 20 to generate the secondary flow 208 through the window 210 opened when the mobile cowl 207 moves from the closed position to the open position.

In the embodiment of the disclosure shown in FIGS. 9A-9C, the mobile cowl, generally designated 207, features an interior wall and an exterior wall that are moved in the same manner and simultaneously. The exterior wall is the wall that comes into alignment with the reverser flap 104 in the closed position (see FIG. 6A) and constitutes an exterior wall of the nacelle 900, while the interior wall defines the peripheral surface of the passage for the primary airflow 202 around the engine 20.

FIG. 9A shows the components of the nacelle 900 in the closed position, with the reverser flap 104 being accommodated in part between the interior and exterior walls of the mobile cowl 207, and the second flap 602 being in its closed position and accommodated between the interior wall and the exterior wall.

FIG. 9C shows the components of the nacelle 900 in the open position, with the reverser flap 104 and the second flap 602 in their respective open positions positioned upstream (e.g., relative to the direction of primary airflow 202) of the mobile cowl 207 and, furthermore, positioned across the passage that defines the primary airflow 202, at least partially or entirely blocking the flow of the primary airflow 202.

FIG. 9B shows the same elements illustrated in the closed position in the solid lines and in the open position in the broken lines

The nacelle 900 also features an upstream wall 604 that has a cutout to accommodate the second flap 602, the upstream wall 604 extending upstream of the interior wall of the mobile cowl 207, relative to the longitudinal axis x, and constitutes an exterior wall of the passage for the primary airflow 202 around the engine 20. The upstream wall 604 is fixed relative to the structure of the nacelle 900 and is situated substantially at the level of the front frame. In the closed position, at an upstream end, the interior wall of the mobile cowl 207 is located proximate to and as an aerodynamic extension of the upstream wall 604. In the open position, the interior wall of the mobile cowl 207 is located far away from the upstream wall 604 so as to open the window 210 and allow the reverser flap 104 and the second flap 602 to be positioned to block or obstruct the primary airflow 202.

As described in previous example embodiments, the reverser flap 104 is rotatably mounted about a first rotation axis to pass from the closed position to the open position, and vice versa. The movements of the mobile cowl 207 and the reverser flap 104 conform to those described above and are assured by an appropriate drive mechanism.

In the embodiment of the disclosure herein shown in FIGS. 9A-10, the drive mechanism is configured to move the mobile cowl 207 from the closed position to the open position, and vice versa and, to this end, can include, for example, slides, actuators, motors, or any other appropriate mechanisms and/or structures for moving an element in translation.

In this embodiment, the second flap 602 is also rotatably mounted about a second rotation axis on the structure of the nacelle 900 to pass between and including its closed and open positions, and vice versa. In this embodiment, the first and second rotation axes are different, but in other configurations they can be identical (e.g., co-located along a single axis).

The movements of the second flap 602 are similar to and synchronized with those of the reverser flap 104. To this end the drive mechanism is configured to coordinate the movements of the second flap 602 with those of the reverser flap 104; that is to say, the passage of the second flap 602 between and including its closed and open positions is coordinated with the passage of the reverser flap 104 between and including its respective closed and open positions, and vice versa. This coordinated movement is achieved, in the example embodiment shown, by links connecting the second flap 602 and the reverser flap 104 and a motor, or actuators, controlled as a function of the movement of the reverser flap 104.

For even better control of the secondary flow 208 when the window 210 is open, the nacelle 900 includes a plurality of deflectors, generally designated 608, that are attached to the upstream wall 604 in a manner that protrudes, at least partially, downstream into the opening for the secondary flow 208 that is defined by the window 210 (e.g., globally at the level of the zone of the transition from the passage for the primary airflow 202 to the window 210). This plurality of deflectors protruding into the window 210 makes it possible to improve the area match and the total effectiveness of the thrust reverser, by deviating (e.g., more fully aerodynamically developing to reduce turbulence of the secondary flow 208) the upstream part of the reversed flow strongly forwards, which tends to strongly improve the flow and the opposite thrust in this part of flow.

The deflectors 608 are positioned in the space available between the translation path 207P of the mobile cowl 207 and the movement path 602P of the second flap 602. The translation path 207P is the path, schematically illustrated in FIG. 9B, that the leading edge of the interior flow surface (e.g., forming the passage through which primary airflow 202 flows) of mobile cowl 207 traverses when passing from the closed position (FIG. 9A and the solid line illustration in FIG. 9B) to the open position (FIG. 9C and the broken line illustration in FIG. 9B) to open window 210 (see FIG. 9C). The movement path 602P is the path, schematically illustrated in FIG. 9B, that the second flap 602 traverses when moving from the closed position to the open position, in which the second flap 602 is positioned to block, at least partially or entirely, the passage for primary airflow 202, to generate secondary flow 208. As shown, the movement path 602P has aspects of both translatory and rotational movement as the second flap 602 moves between the open and closed positions. Because of the positioning of the second flap 602 outside of the passage for the primary airflow (e.g., within a notch formed in upstream wall 604 and/or vertically within the bounds of the mobile cowl 207), and also in order to avoid contacting the plurality of deflectors 608 when moving between the closed and open positions, the movement path 602P has a generally curved shape so that no portion of the second flap will make contact with any of the deflectors 608 when moving from the closed position to the open position, and vice versa. Translation path 207P and movement path 602P may each have any suitable shape depending on the geometry of the surrounding structural elements of the nacelle 900 (e.g., upstream wall 604) that must be maneuvered around as these structures move between and including the closed position and the open position, and vice versa.

The space available according to these spatial constraints and the need for performance of the reverse thrust force produced by the secondary flow 208 can be used to determine the number, the spacing, the size, the shape, etc. of each of the plurality of deflectors 608. In some embodiments, one or more of (e,g., each of, or all of) the plurality of deflectors 608 may differ in one or more of spacing (e.g., pitch), size, shape from one or more of (e.g., an adjacent) deflector 608. In the example embodiment of FIGS. 9A-10, about one-third of the total opening is used, but any other suitable amount of usage of the total opening may be used. The plurality of deflectors 608 are positioned to ensure a certain ratio between their height and their spacing (e.g., a ratio between 1 and 2, but evolutionary heights and spacings will be understood by those having ordinary skill in the art), which defines the full number of deflectors 608. Advantages compared to a long deflector that spans the entire length of the window 210 include, for example, lower cost and reduced mass.

While the plurality of deflectors 608 in FIGS. 9A-10 are illustrated as not being connected to each other or to any other structure of the aircraft (e.g., upstream wall 604), the connecting elements used to secure the deflectors 608 in a static position relative to upstream wall 604 are merely omitted to allow for visualization of the airflow vectors for secondary flow 208 when window 210 is open. Any suitable connecting element may be used to secure the plurality of deflectors 608 to each other and to any suitable structure of the aircraft, including but not limited to upstream wall 604.

As shown in FIG. 10, the small length of the plurality of deflectors 608 is effective because it acts in the zone where the secondary flow 208 has the most difficulty turning (e.g., adjacent to upstream wall 604 to create push transfers and/or a reverse thrust force). As such, this plurality of deflectors 608 supplements the action of the reverse flap 104 and second flap 602, which are known to act, due to the high inlet velocity of the air stream that would otherwise constitute primary airflow 202, rather than on the median and aft parts of the flow, such as are shown at 209.

Each deflector 608 is fixed to the structure of the nacelle 900 and, in the embodiment shown, is fixed to the upstream wall 604. Each deflector 608 takes, in some embodiments, the form of an aileron that orients the secondary flow 208 toward the window 210 to more fully develop secondary flow 208 at a leading edge of window 210 adjacent to upstream wall. In some embodiments, the portion of the secondary flow 208 that is more fully developed by the plurality of deflectors 608 has an increased mass flow rate and/or velocity in the region of the window 210 in which the plurality of deflectors 608 are arranged, compared to an embodiment with only a single (or none entirely) deflector attached to the upstream wall 604. In the closed position, each deflector 608 is accommodated within the mobile cowl 207 (e.g., between the interior and exterior walls of the mobile cowl 207).

The drive mechanism can be adapted or configured to assure simultaneous movements of the reverser flap 104 and the mobile cowl 207 in the two combinations provided that the dimensional characteristics of the reverser flap 104 and the mobile cowl 207 do not create any interference between them during their movements.

The drive mechanism can also be adapted or configured to assure a delayed movement of the reverser flap 104 in the first combination and a delayed movement of the mobile cowl 207 in the second combination.

The disclosure herein has been more particularly described in the case of a nacelle under a wing but can be applied to a nacelle located at the rear of the fuselage.

While at least one exemplary embodiment of the invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A nacelle for a turbofan, the nacelle comprising:
a fixed cowl and a mobile cowl, the mobile cowl being mobile along a translation path between a closed position, in which the mobile cowl is adjacent to the fixed cowl, and an open position, in which the mobile cowl is far aft of the fixed cowl, wherein a passage is defined for a primary airflow between, on an inner surface thereof, an engine of the turbofan and, on an outer surface thereof, the fixed cowl and the mobile cowl;
a window, which is delimited, on an upstream side thereof, by the fixed cowl and, on a downstream side thereof, by the mobile cowl, wherein, when the mobile cowl is in the open position, the window is open to allow a secondary flow to exit the passage for the primary airflow to an exterior of the nacelle through the window;
a reverser flap which is mounted in a manner rotatable about a rotation axis between the closed position, in which the window is obstructed, and an open position, in which the window is not obstructed;
a second flap configured to move along a movement path between the closed position, in which the second flap is positioned out of the passage for the primary airflow, and the open position, in which the second flap is positioned within, at least partially, the passage for the primary airflow, to extend the reverser flap in the open position to be located within, at least partially, the passage for the primary airflow, and to rotate about a rotation axis while moving along the movement path;
a drive mechanism comprising:
a motor element with a mobile part secured to the mobile cowl to drive the mobile part in translation;
a guide, which is secured to the mobile cowl and comprises a slide part, an axis of which is parallel to the translation path of the mobile cowl, and a rotation part that extends the slide part forward and is offset relative to the slide part;
a slider of the rotation part accommodated in the guide;
a first link articulated between the slider and the reverser flap;
a second link articulated between the slider and the second flap; and
an abutment configured to move the slider toward the slide part when the reverser flap and the second flap are in the closed position and the mobile cowl is moved from the open position to the closed position; and
a plurality of deflectors that are arranged in a position such that, when the window is open, the plurality of deflectors are positioned at a leading edge of the window,
wherein the drive mechanism is configured to control passage of the reverser flap and the mobile cowl between and including the closed and open positions,
wherein the drive mechanism is configured for a first combination assuring, from the closed position:
an aft translation of the mobile cowl along the translation path to move the mobile cowl from the closed position to the open position, and
a rotation of the reverser flap about the rotation axis to move the reverser flap from the closed position to the open position,
wherein the drive mechanism is configured for a second combination assuring, from the open position:
a rotation of the reverse flap in a reverse direction about the rotation axis to move the reverser flap from the open position to the closed position, and
a forward translation of the mobile cowl along the translation path to move the mobile cowl from the open position to the closed position, and
wherein the drive mechanism is configured to coordinate passage of the second flap and the reverser flap between and including the closed and open positions.

2. The nacelle of claim 1, wherein the second flap carries a seal that is positioned between the reverser flap and the second flap when the reverser flap and the second flap are in the open position.

3. The nacelle of claim 1, wherein the drive mechanism is configured to move the reverser flap and the mobile cowl simultaneously.

4. The nacelle of claim 1, wherein the drive mechanism is configured to cause a delayed movement of the reverser flap in the first combination and a delayed movement of the mobile cowl in the second combination.

5. The nacelle of claim 1, wherein the plurality of deflectors are configured to increase a velocity and/or a mass flow rate of the secondary flow through a region of the window in which the plurality of deflectors are arranged.

6. The nacelle of claim 1, wherein the plurality of deflectors are located between an internal surface and an external surface of the mobile cowl.

7. The nacelle of claim 1, wherein the plurality of deflectors are located within a region between the translation path of the mobile cowl and the movement path of the second flap.

8. The nacelle of claim 7, wherein the movement path of the second flap is defined by a leading edge of an internal surface of the mobile cowl.

9. A turbofan comprising:
an engine; and
a nacelle according to claim 1,
wherein the nacelle is configured to surround the engine, and
wherein a secondary flow, which is configured to generate a reverse thrust force, is delimited between the nacelle and the engine.

10. An aircraft comprising at least one turbofan according to claim 9.

11. A nacelle for a turbofan, the nacelle comprising:
a fixed cowl and a mobile cowl, the mobile cowl being mobile along a translation path between a closed position, in which the mobile cowl is adjacent to the fixed cowl, and an open position, in which the mobile cowl is far aft of the fixed cowl, wherein a passage is defined for a primary airflow between, on an inner surface thereof, an engine of the turbofan and, on an outer surface thereof, the fixed cowl and the mobile cowl;
a window, which is delimited, on an upstream side thereof, by the fixed cowl and, on a downstream side thereof, by the mobile cowl, wherein, when the mobile cowl is in the open position, the window is open to allow a secondary flow to exit the passage for the primary airflow to an exterior of the nacelle through the window;
a reverser flap which is mounted in a manner rotatable about a rotation axis between the closed position, in which the window is obstructed, and an open position, in which the window is not obstructed;
a second flap configured to move along a movement path between the closed position, in which the second flap is positioned out of the passage for the primary airflow, and the open position, in which the second flap is positioned within, at least partially, the passage for the primary airflow, to extend the reverser flap in the open position to be located within, at least partially, the passage for the primary airflow, and to rotate about a rotation axis while moving along the movement path;
a drive mechanism comprising:
an actuator with a first rod, which is secured to the mobile cowl, and a second rod;
an activator configured to selectively move the first rod and the second rod;
a first link articulated between the second rod and the reverser flap; and
a second link articulated between the second rod and the second flap; and
a plurality of deflectors that are arranged in a position such that, when the window is open, the plurality of deflectors are positioned at a leading edge of the window,
wherein the drive mechanism is configured to control passage of the reverser flap and the mobile cowl between and including the closed and open positions,
wherein the drive mechanism is configured for a first combination assuring, from the closed position:
an aft translation of the mobile cowl along the translation path to move the mobile cowl from the closed position to the open position, and
a rotation of the reverser flap about the rotation axis to move the reverser flap from the closed position to the open position,
wherein the drive mechanism is configured for a second combination assuring, from the open position:
a rotation of the reverse flap in a reverse direction about the rotation axis to move the reverser flap from the open position to the closed position, and
a forward translation of the mobile cowl along the translation path to move the mobile cowl from the open position to the closed position, and
wherein the drive mechanism is configured to coordinate passage of the second flap and the reverser flap between and including the closed and open positions.

12. The nacelle of claim 11, wherein the second flap carries a seal that is positioned between the reverser flap and the second flap when the reverser flap and the second flap are in the open position.

13. The nacelle of claim 11, wherein the drive mechanism is configured to move the reverser flap and the mobile cowl simultaneously.

14. The nacelle of claims 11, wherein the drive mechanism is configured to cause a delayed movement of the reverser flap in the first combination and a delayed movement of the mobile cowl in the second combination.

15. The nacelle of claim 11, wherein the plurality of deflectors are configured to increase a velocity and/or a mass flow rate of the secondary flow through a region of the window in which the plurality of deflectors are arranged.

16. The nacelle of claim 11, wherein the plurality of deflectors are located between an internal surface and an external surface of the mobile cowl.

17. The nacelle of claim 11, wherein the plurality of deflectors are located within a region between the translation path of the mobile cowl and the movement path of the second flap.

18. The nacelle of claim 17, wherein the movement path of the second flap is defined by a leading edge of an internal surface of the mobile cowl.

19. A turbofan comprising:
an engine; and
a nacelle according to claim 11,
wherein the nacelle is configured to surround the engine, and
wherein an airflow of a secondary flow is delimited between the nacelle and the engine.

20. An aircraft comprising at least one turbofan according to claim 19.
